(19) United States
(12) Patent Application Publication
(10) Pub. No.: US 2026/0166980 A1
(43) Pub. Date: Jun. 18, 2026

(54) BATTERY PACK

(71) Applicant: HONDA MOTOR CO., LTD., Tokyo (JP)

(72) Inventors: Yuji HAGA, Tokyo (JP); Kenzo IKEDA, Tokyo (JP); Yoshitaka KUNIMATSU, Tokyo (JP)

(73) Assignee: HONDA MOTOR CO., LTD., Tokyo (JP)

(21) Appl. No.: 19/409,793

(22) Filed: Dec. 5, 2025

(30) Foreign Application Priority Data
Dec. 12, 2024 (JP) 2024-218093

(51) Int. Cl. B60K 1/04; B60L 50/64; H01M 50/249

(52) U.S. Cl. CPC B60K 1/04; B60L 50/64; H01M 50/249; H01M 2220/20

(57) ABSTRACT

A battery pack to be mounted on a vehicle, includes: a battery; a case accommodating the battery; a case frame disposed outside the case and configured to fix the case to a vehicle body; and a battery frame disposed inside the case and configured to fix the battery to the case, the case includes a bottom wall, and a first side wall as defined herein, the case frame includes a first flange portion, a second flange portion, and a main body portion as defined herein, the battery frame includes a bottom portion extending in the first direction along the bottom wall of the case and joined to an inner surface of the bottom wall, and when viewed from above, at least a part of the bottom portion of the battery frame overlaps one of the first flange portion or the second flange portion of the case frame.

### CROSS-REFERENCE TO RELATED APPLICATION

This application is based on and claims priority under 35 USC 119 from Japanese Patent Application No. 2024-218093 filed on Dec. 12, 2024.

### TECHNICAL FIELD

The present invention relates to a battery pack to be mounted on a vehicle.

### BACKGROUND ART

In recent years, researches and developments have been conducted on a secondary battery which contributes to improvement in energy efficiency in order to allow more people to have access to affordable, reliable, sustainable and advanced energy.

In a battery pack support structure in a battery pack described in Patent Literature 1, a front side and a rear side of a stack formed by stacking a plurality of battery modules are fixed to a bottom surface of a pack case via brackets and fixing metal fittings. A cross beam bent in a hat shape is joined to the bottom surface of the pack case and inner surfaces of left and right side walls by welding or the like, and the brackets and the fixing metal fittings are welded to a top surface of the cross beam.

Patent Literature 1: JP2016-219262A

### SUMMARY OF INVENTION

The number of battery cells constituting each battery module may be different in different vehicle types or even different grades of the same vehicle type, and front and rear sizes of the battery module and the stack may vary. In the battery pack support structure described in Patent Literature 1, fixing portions for the batteries in the pack case are reinforced by the cross beam, and the cross beam is provided inside the pack case. When the pack case is shared by the battery modules and the stacks having different sizes, the cross beam is moved according to the sizes of the battery modules and the stacks.

An object of the present invention to provide a battery pack that is compatible with batteries of different sizes.

An aspect of the present invention is a battery pack to be mounted on a vehicle, the battery pack including:
a battery;
a case accommodating the battery;
a case frame disposed outside the case and configured to fix the case to a vehicle body;
a battery frame disposed inside the case and configured to fix the battery to the case, in which
the case includes
   a bottom wall on which the battery is placed, and
   a first side wall extending upward from a first edge of the bottom wall extending in a first direction, and facing the battery in a second direction orthogonal to the first direction,
the case frame includes
   a first flange portion extending in the first direction along the bottom wall of the case and joined to an outer surface of the bottom wall,
   a second flange portion disposed at an interval from the first flange portion in the second direction, extending in the first direction along the bottom wall of the case, and joined to the outer surface of the bottom wall, and
   a main body portion connecting the first flange portion and the second flange portion and forming a closed cross section with the bottom wall of the case in a cross section perpendicular to the first direction,
the battery frame includes a bottom portion extending in the first direction along the bottom wall of the case and joined to an inner surface of the bottom wall, and
when viewed from above, at least a part of the bottom portion of the battery frame overlaps one of the first flange portion or the second flange portion of the case frame.

According to the present invention, it is possible to provide a battery pack that is compatible with batteries of different sizes.

### BRIEF DESCRIPTION OF DRAWINGS

FIG. 1 is a schematic diagram of an example of a vehicle for illustrating an embodiment of the present invention.

FIG. 2 is an exploded perspective view of a battery pack mounted on the vehicle of FIG. 1.

FIG. 3 is a plan view of the battery pack showing an arrangement example of a battery frame in the battery pack of FIG. 2.

FIG. 4 is a cross-sectional view of the battery pack of FIG. 3.

FIG. 5 is a plan view of the battery pack showing another arrangement example of the battery frame in the battery pack of FIG. 2.

FIG. 6 is a cross-sectional view of the battery pack of FIG. 5.

FIG. 7 is a schematic diagram illustrating downsizing of the battery pack of FIG. 2.

FIG. 8 is a perspective view of a fixing base and an extending portion provided at an end portion of the battery frame of FIG. 2.

FIG. 9 is a perspective view of the extending portion provided at an end portion of a case frame of FIG. 2.

### DESCRIPTION OF EMBODIMENTS

An example of a vehicle for illustrating an embodiment of the present invention will be described with reference to the accompanying drawings. The drawings are viewed from directions of reference numerals. In the present specification and the like, in order to simplify and clarify the description, a front-rear direction, a left-right direction, and an upper-lower direction are described according to a direction viewed from a driver of a vehicle, and in the drawings, a front side of the vehicle is shown as Fr, a rear side is shown as Rr, a left side is shown as L, a right side is shown as R, an upper side is shown as U, and a lower side is shown as D.

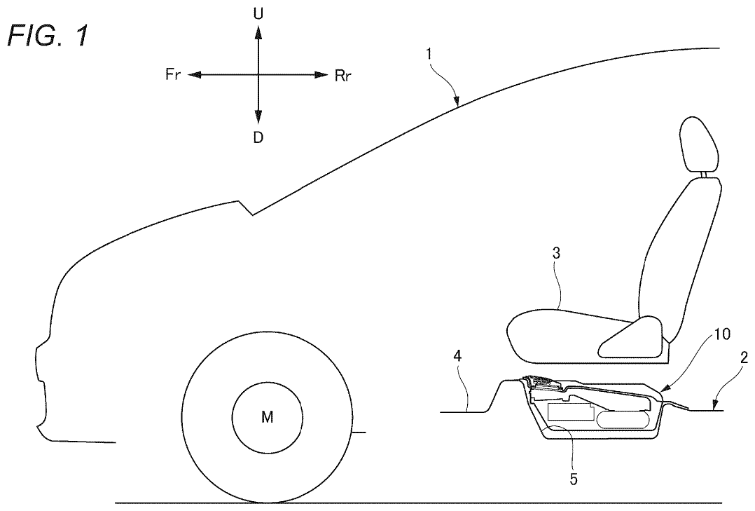

A vehicle 1 shown in FIG. 1 is an electric vehicle such as a battery electric automobile, a hybrid vehicle (including a plug-in hybrid vehicle), or a fuel cell vehicle. The vehicle 1 includes a vehicle body 2, a seat 3, and a battery pack 10. The vehicle body 2 constitutes a framework of the vehicle 1, and the battery pack 10 stores and discharges electric power to be supplied to a motor M or the like serving as a drive source of the vehicle.

The vehicle body 2 includes a floor panel 4. The floor panel 4 constitutes a part of the framework of a vehicle lower part. Although not shown, the vehicle body 2 may include, as members constituting the framework of the vehicle lower part, a pair of side sills extending in a vehicle front-rear direction along both side portions of the floor panel 4, a cross member bridged between the pair of side sills, and the like. The seat 3 is installed on the floor panel 4.

The battery pack 10 is also installed on the floor panel 4, and is located below the seat 3 in the example shown in FIG. 1. A recessed portion 5 is formed in the floor panel 4, and the battery pack 10 is accommodated in the recessed portion 5. An interior space of the vehicle 1 can be enlarged by accommodating the battery pack 10 in a space under the seat that is a dead space.

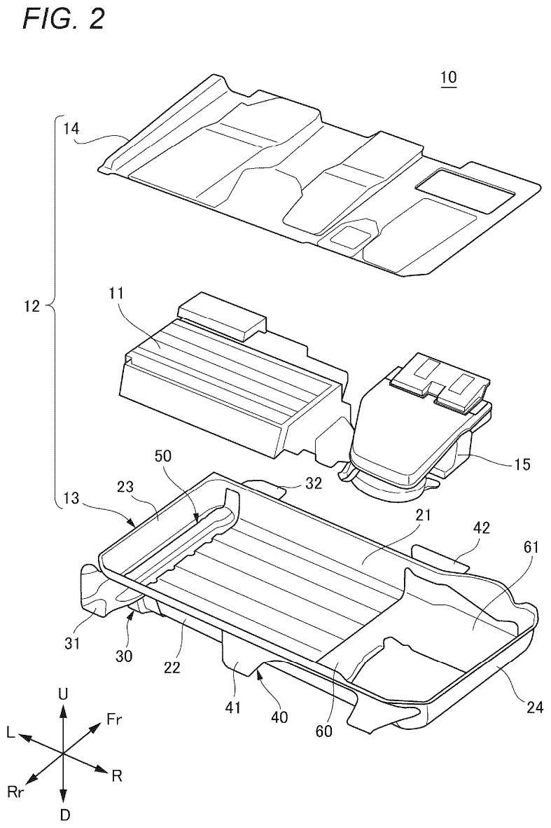

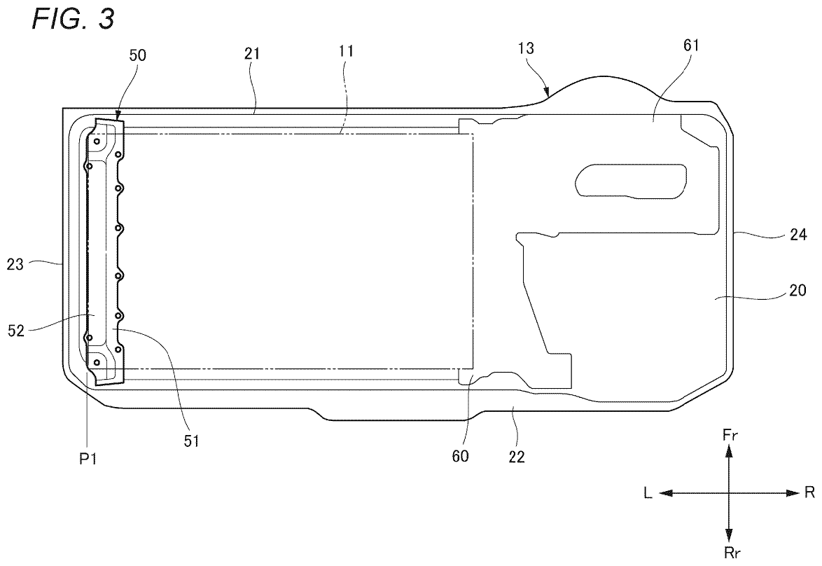

As shown in FIGS. 2 and 3, the battery pack 10 includes batteries 11 and a case 12 that accommodates the batteries 11. Each of the batteries 11 includes a plurality of battery cells. The battery cell is, for example, a lithium-ion battery or nickel-hydrogen battery using a liquid electrolyte, or an all-solid-state battery using a solid electrolyte. The battery 11 is typically modularized in a state where the plurality of battery cells are connected in series and/or in parallel.

The case 12 includes a case body 13 and a case cover 14. The case body 13 is formed in a tray shape capable of accommodating the batteries 11. The case body 13 is, for example, formed by a plate member made of metal such as an aluminum alloy or steel. The case cover 14 covers the case body 13 from above. The case cover 14 is formed by a steel plate.

The case 12 further accommodates electrical devices such as a junction box 15 and a bus bar. The junction box 15 controls a connection between a charging system mounted on the vehicle and the battery pack 10, and a connection between an inverter that drives the motor M and the battery pack 10. The bus bar connects the modularized batteries 11 to each other, and connects the batteries 11 and the junction box 15.

The case body 13 formed in a tray shape includes a bottom wall 20 on which the batteries 11 and the junction box 15 are placed, and side walls 21, 22, 23, and 24 extending upward from front, rear, left and right edges of the bottom wall 20. The side walls 21 and 22 are disposed facing each other in the vehicle front-rear direction, and each extends in a vehicle width direction. The side walls 23 and 24 are disposed facing each other in the vehicle width direction, and each extends in the vehicle front-rear direction.

The batteries 11 and the junction box 15 are disposed adjacently in the vehicle width direction, the batteries 11 are disposed adjacent to the left side wall 23 in the vehicle width direction, and the junction box 15 is disposed adjacent to the right side wall 24 in the vehicle width direction.

The battery pack 10 further includes a first case frame 30, a second case frame 40, a first battery frame 50, and a second battery frame 60. The first case frame 30 and the second case frame 40 are disposed outside the case 12 and fix the case 12 to the vehicle body 2. The first battery frame 50 and the second battery frame 60 are disposed inside the case 12 and fix the batteries 11 to the case body 13. In the example shown in FIG. 2, the second battery frame 60 is integrally provided with a fixing plate 61 that fixes the junction box 15 to the case body 13.

The first battery frame 50 and the second battery frame 60 are disposed at an interval in the vehicle width direction, and each extends in the vehicle front-rear direction. The first battery frame 50 and the second battery frame 60 are joined to an inner surface of the bottom wall 20 of the case body 13 by an appropriate method such as welding or fastening using bolts or rivets. The first battery frame 50 supports, among side portions of each of the batteries 11 in the vehicle width direction, a side portion near the side wall 23 of the case body 13, and the second battery frame 60 supports a side portion of the battery 11 near the junction box 15.

The first case frame 30 and the second case frame 40 each extend in the vehicle front-rear direction. End portions 31 and 32 of the first case frame 30 on both sides in the vehicle front-rear direction protrude outward from the case body 13, and the end portions 31 and 32 are fixed to the vehicle body 2. Similarly, end portions 41 and 42 of the second case frame 40 on both sides in the vehicle front-rear direction protrude outward from the case body 13, and the end portions 41 and 42 are fixed to the vehicle body 2.

The first case frame 30 is disposed to overlap the first battery frame 50 with the bottom wall 20 of the case body 13 interposed therebetween, and reinforces a joining region of the bottom wall 20 joined to the first battery frame 50. The second case frame 40 is disposed to overlap the second battery frame 60 with the bottom wall 20 interposed therebetween, and reinforces a joining region of the bottom wall 20 joined to the second battery frame 60.

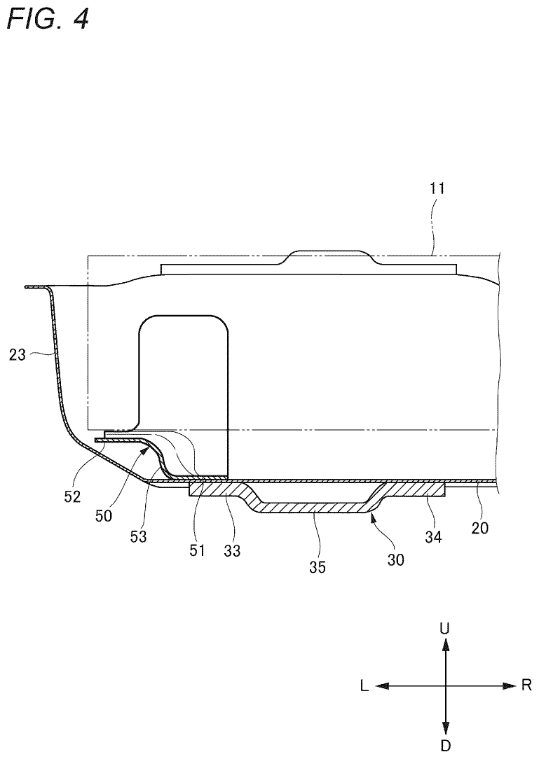

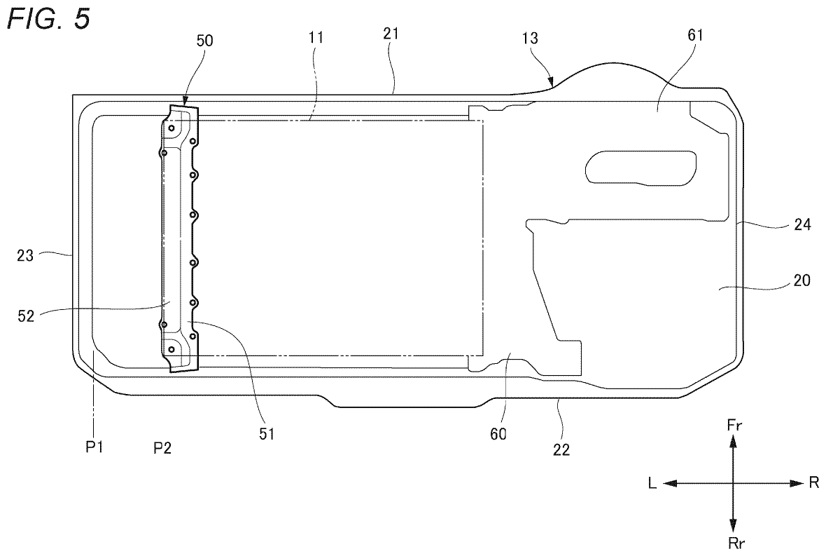

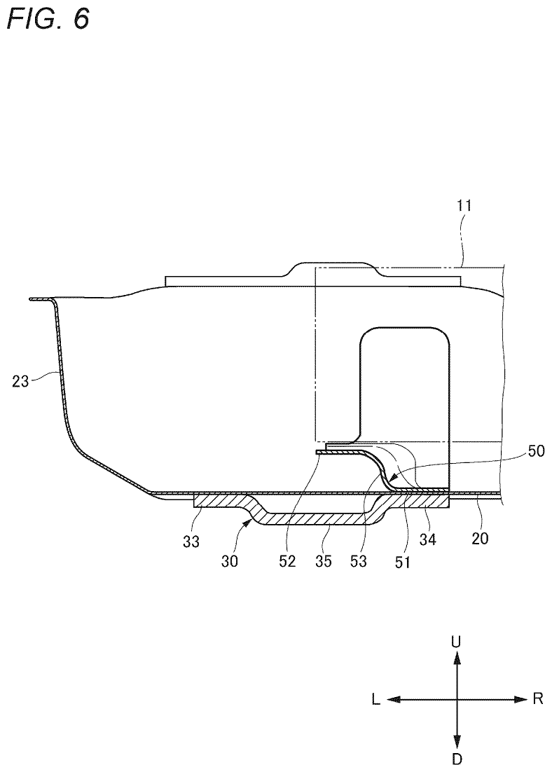

FIGS. 3 to 6 show arrangement examples of the first battery frame 50 corresponding to a size of the battery 11, in which a dimension of the battery 11 in the vehicle width direction is relatively large in FIGS. 3 and 4, and the dimension of the battery 11 in the vehicle width direction is relatively small in FIGS. 5 and 6. The arrangement of the second battery frame 60 is fixed regardless of the dimension of the battery 11 in the vehicle width direction.

As shown in FIGS. 3 and 4, in a case where the dimension of the battery 11 in the vehicle width direction is relatively large, the first battery frame 50 that supports, among the side portions of the battery 11 in the vehicle width direction, the side portion near the side wall 23 of the case body 13 is disposed at a first position P1 adjacent to the side wall 23. Meanwhile, as shown in FIGS. 5 and 6, in a case where the dimension of the battery 11 in the vehicle width direction is relatively small, the first battery frame 50 is disposed at a second position P2 shifted from the first position P1 toward a center of the case body 13 in the vehicle width direction. The first battery frame 50 includes a bottom portion 51 extending in the vehicle front-rear direction along the bottom wall 20 of the case body 13, and the bottom portion 51 is joined to the inner surface of the bottom wall 20.

The first case frame 30 includes a first flange portion 33, a second flange portion 34, and a main body portion 35. The first flange portion 33 extends in the vehicle front-rear direction along the bottom wall 20, and is joined to an outer surface of the bottom wall 20 by an appropriate method such as welding or fastening using bolts or rivets. The second flange portion 34 is disposed at an interval from the first flange portion 33 in the vehicle width direction, extends in the vehicle front-rear direction along the bottom wall 20, and is joined to the outer surface of the bottom wall 20. The main body portion 35 connects the first flange portion 33 and the second flange portion 34. The main body portion 35 is formed in a U shape in a cross section perpendicular to the vehicle front-rear direction, forms a closed cross section with the bottom wall 20, and reinforces the bottom wall 20.

As shown in FIGS. 3 and 4, when the first battery frame 50 is disposed at the first position P1, at least a part of the bottom portion 51 of the first battery frame 50 overlaps the first flange portion 33 of the first case frame 30 when viewed from above. Meanwhile, as shown in FIGS. 5 and 6, when the first battery frame 50 is disposed at the second position P2, at least a part of the bottom portion 51 of the first battery frame 50 overlaps the second flange portion 34 of the first case frame 30 when viewed from above.

In this way, the first case frame 30 for reinforcing the joining region of the bottom wall 20 of the case body 13 joined to the first battery frame 50 is disposed outside the case 12, and thus the case 12 is compatible with batteries 11 of different sizes by moving only the first battery frame 50, that fixes the battery 11 to the bottom wall 20, according to the size of the battery 11 while maintaining the disposition of the first case frame 30.

Preferably, the bottom portion 51 of the first battery frame 50, the bottom wall 20 of the case body 13, and any one of the first flange portion 33 or the second flange portion 34 of the first case frame 30 are integrally joined. Thus, rigidity of the first case frame 30, the first battery frame 50, and the case body 13 as a whole can be increased. Here, the bottom portion 51, the bottom wall 20, and any one of the first flange portion 33 or the second flange portion 34 being integrally joined means that any one of the first flange portion 33 or the second flange portion 34 is further joined to a joining portion between the bottom portion 51 and the bottom wall 20.

The first battery frame 50 is not particularly limited as long as the above-described bottom portion 51 is provided, and for example, the first battery frame 50 may be formed in a rectangular shape or a C shape in a cross section perpendicular to the vehicle front-rear direction, but in the present example, the first battery frame 50 is formed in a crank shape in the cross section perpendicular to the vehicle front-rear direction. Specifically, the first battery frame 50 includes a top portion 52 that is separated upward from the bottom wall 20 of the case body 13 and extends in the vehicle front-rear direction, and a connection portion 53 that connects the bottom portion 51 and the top portion 52. The connection portion 53 extends upward from, among edges on both sides of the bottom portion 51 in the vehicle width direction, an edge near the side wall 23 of the case body 13, and the top portion 52 extends from an upper end of the connection portion 53 toward the side wall 23. The top portion 52 is in a so-called cantilever state in which only an edge on a side opposite to the side wall 23 is supported by the connection portion 53.

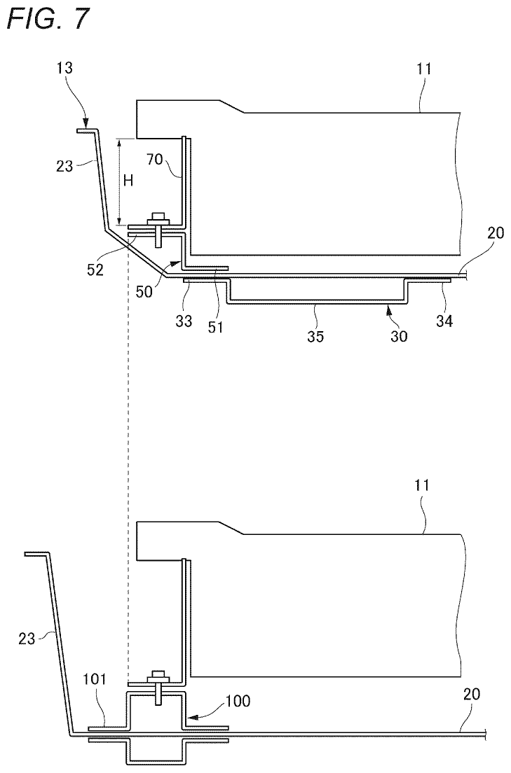

As shown in FIG. 7, such a crank-shaped first battery frame 50 contributes to downsizing of the battery pack 10. Taking a battery pack including a battery frame 100 formed in a hat shape in a cross section perpendicular to the vehicle front-rear direction as a comparison target reference example, in the battery pack 10 including the first battery frame 50, the side wall 23 of the case body 13 is shifted toward a center in the vehicle width direction. Conversely, in comparison with the first battery frame 50, an L-shaped support wall 101 that supports the edge of the top portion 52 near the side wall 23 is added to the battery frame 100, and in the battery pack of the reference example, the side wall 23 is pushed outward by an amount of the support wall 101.

Further, in the battery pack 10 including the first battery frame 50, a base end portion of the side wall 23 of the case body 13 enters below the top portion 52, and the case body 13 is further downsized.

The battery 11 may be dropped between the first battery frame 50 and the second battery frame 60. In the example shown in FIG. 7, an L-shaped bracket 70 is attached to a side portion of the battery 11 facing the side wall 23 of the case body 13, and the bracket 70 is fixed to the top portion 52 of the first battery frame 50. The battery 11 is disposed on a side opposite to the side wall 23 with respect to the top portion 52, and a bottom of the battery 11 is disposed lower than the top portion 52 by appropriately setting a height H of the bracket 70. Although not shown, surroundings of the second battery frame 60 are configured in the same manner. Thus, a height of the battery pack 10 can be reduced.

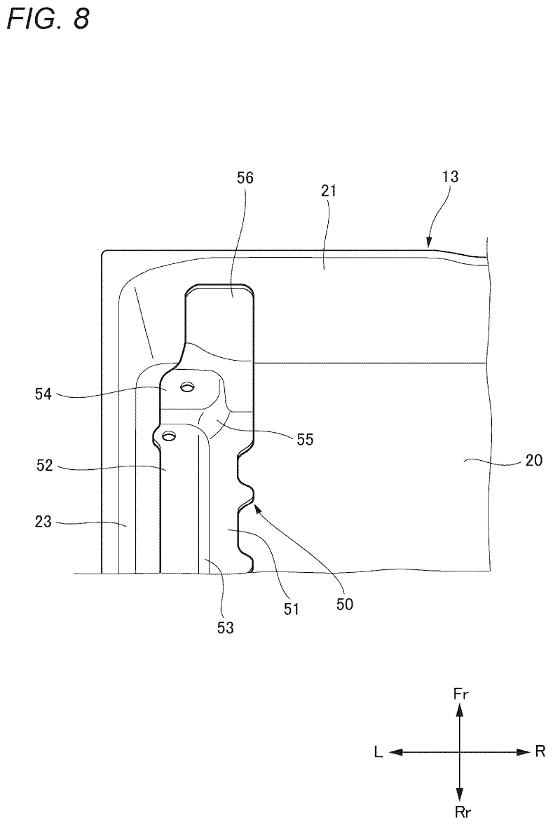

Fixing bases 54 to each of which the bracket 70 is fixed are provided at end portions of the top portion 52 of the first battery frame 50 on both sides in the vehicle front-rear direction. As shown in FIG. 8, the fixing base 54 protrudes further toward a side opposite to the side wall 23 of the case body 13 along the vehicle width direction than an intermediate portion of the top portion 52 in the vehicle front-rear direction. Each of end portions 55 on both sides of the connection portion 53 of the first battery frame 50 in the vehicle front-rear direction continuous with the fixing bases 54 bulges further toward the side opposite to the side wall 23 along the vehicle width direction than an intermediate portion of the connection portion 53 in the vehicle front-rear direction. A shape of the first battery frame 50 becomes three-dimensional by the fixing bases 54 of the top portion 52 and the end portions 55 of the connection portion 53, and deflection of the top portion 52 in the cantilever state can be prevented.

From a viewpoint of increasing the rigidity of the first case frame 30 and the first battery frame 50, the first case frame 30 and the first battery frame 50 may extend along the side wall 21 and the side wall 22 in the vehicle front-rear direction of the case body 13.

As shown in FIG. 8, the first battery frame 50 includes an extending portion 56 extending from one end of each of the bottom portion 51, the top portion 52, and the connection portion 53 in the vehicle front-rear direction near the side wall 21. The extending portion 56 extends upward along an inner surface of the side wall 21 and is joined to the inner surface of the side wall 21. Although not shown, a similar extending portion is also provided at one end of the first battery frame 50 in the vehicle front-rear direction near the side wall 22, and is joined to an inner surface of the side wall 22. Thus, the shape of the first battery frame 50 becomes three-dimensional, and the deflection of the top portion 52 in the cantilever state can be prevented.

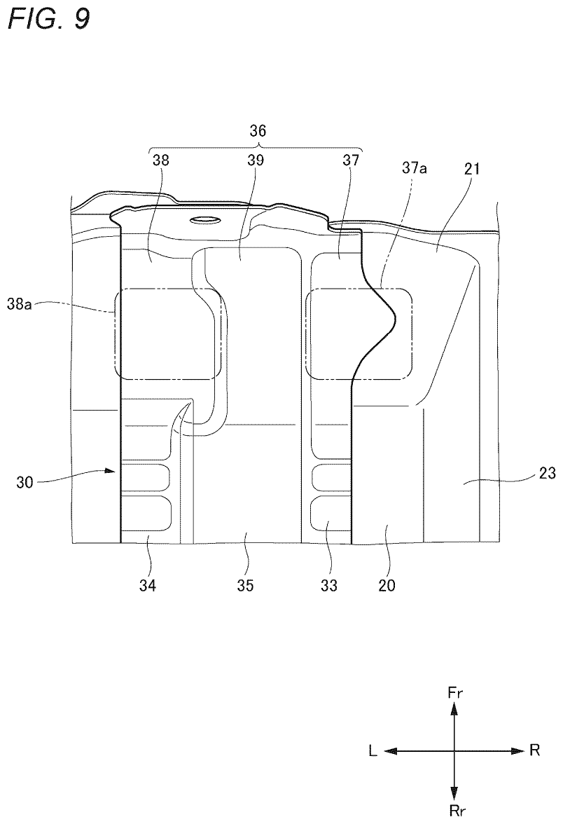

As shown in FIG. 9, the first case frame 30 includes an extending portion 36 that extends from one end of each of the first flange portion 33, the second flange portion 34, and the main body portion 35 in the vehicle front-rear direction near the side wall 21. The extending portion 36 extends upward along an outer surface of the side wall 21 and is joined to the outer surface of the side wall 21. More specifically, the extending portion 36 includes a first flange extending portion 37 continuous with the first flange portion 33, a second flange extending portion 38 continuous with the second flange portion 34, and a main body extending portion 39 continuous with the main body portion 35, and the first flange extending portion 37 and the second flange extending portion 38 are joined to the outer surface of the side wall 21. Although not shown, a similar extending portion is also provided at one end of the first case frame 30 in the vehicle front-rear direction near the side wall 22, and is joined to an outer surface of the side wall 22. Thus, the joining region of the case body 13 joined to the first battery frame 50 can be further reinforced.

Preferably, the extending portion 36 of the first case frame 30, the extending portion 56 of the first battery frame 50, and the side wall 21 of the case body 13 are integrally joined. The rigidity of the first case frame 30, the first battery frame 50, and the case body 13 as a whole can be increased.

Preferably, the first flange extending portion 37 of the first case frame 30 has an expanded joining portion 37a that is wider in the vehicle width direction than the first flange portion 33, the second flange extending portion 38 has an expanded joining portion 38a that is wider in the vehicle width direction than the second flange portion 34, and at least the expanded joining portions 37a and 38a are joined to the outer surface of the side wall 21 of the case body 13. The expanded joining portions 37a and 38a are each formed to have substantially the same width as the extending portion 56 of the first battery frame 50, and when the extending portion 36 of the first case frame 30, the extending portion 56 of the first battery frame 50, and the side wall 22 of the case body 13 are integrally joined, a sufficient joining region can be provided at the extending portion 36.

In the present description, at least the following matters are described.

(1) A battery pack (battery pack 10) to be mounted on a vehicle, the battery pack including:
a battery (battery 11);
a case (case 12) accommodating the battery;
a case frame (first case frame 30) disposed outside the case and configured to fix the case to a vehicle body; and
a battery frame (first battery frame 50) disposed inside the case and configured to fix the battery to the case, in which
the case includes
   a bottom wall (bottom wall 20) on which the battery is placed, and
   a first side wall (side wall 23) extending upward from a first edge of the bottom wall extending in a first direction, and facing the battery in a second direction orthogonal to the first direction,
the case frame includes
   a first flange portion (first flange portion 33) extending in the first direction along the bottom wall of the case and joined to an outer surface of the bottom wall,
   a second flange portion (second flange portion 34) disposed at an interval from the first flange portion in the second direction, extending in the first direction along the bottom wall of the case, and joined to the outer surface of the bottom wall, and
   a main body portion (main body portion 35) connecting the first flange portion and the second flange portion and forming a closed cross section with the bottom wall of the case in a cross section perpendicular to the first direction,
the battery frame includes a bottom portion (bottom portion 51) extending in the first direction along the bottom wall of the case and joined to an inner surface of the bottom wall, and
when viewed from above, at least a part of the bottom portion of the battery frame overlaps one of the first flange portion or the second flange portion of the case frame.

According to the battery pack of the above (1), the case frame that reinforces a joining region of the bottom wall of the case joined to the battery frame is disposed outside the case, and thus the case is compatible with batteries of different sizes by moving only the battery frame, that fixes the battery to the bottom wall, to a position overlapping the first flange portion or a position overlapping the second flange portion of the case frame according to the size of the battery while maintaining the arrangement of the case frame.

(2) The battery pack according to the above (1), in which
the bottom portion of the battery frame, the bottom wall of the case, and one of the first flange portion or the second flange portion of the case frame are integrally joined.

According to the battery pack of the above (2), rigidity of the case frame, the battery frame, and the case as a whole can be increased.

(3) The battery pack according to the above (1) or (2), in which
the battery frame includes
   a top portion (top portion 52) extending in the first direction while being separated upward from the bottom wall of the case, and supporting the battery, and
   a connection portion (connection portion 53) connecting the bottom portion and the top portion,
the connection portion extends upward from, among edges on both sides of the bottom portion in the second direction, an edge near the first side wall of the case, and
the top portion extends from an upper end of the connection portion toward the first side wall of the case.

According to the battery pack of the above (3), by setting the top portion of the battery frame to a cantilever state, the first side wall of the case can be shifted toward a center of the case in the second direction, and the battery pack can be downsized.

(4) The battery pack according to the above (3), in which
the battery is disposed on a side opposite to the first side wall of the case with respect to the top portion of the battery frame, and
a bottom of the battery is located lower than the top portion of the battery frame.

According to the battery pack of the above (4), a height of the battery pack can be reduced.

(5) The battery pack according to the above (3), in which
fixing bases (fixing bases 54) to which the battery is fixed are respectively provided at both end portions of the top portion in the first direction,
each of the fixing bases protrudes further toward a side opposite to the first side wall of the case along the second direction than an intermediate portion of the top portion in the first direction, and
each of both end portions (end portions 55) of the connection portion in the first direction continuous with the fixing bases bulges further toward the side opposite to the first side wall of the case along the second direction than an intermediate portion of the connection portion in the first direction.

According to the battery pack of the above (5), a shape of the battery frame becomes three-dimensional, and deflection of the top portion in the cantilever state can be prevented.

(6) The battery pack according to the above (1), in which
the case includes a second side wall (side wall 21) that extends upward from a second edge of the bottom wall extending in the second direction and that faces the battery in the first direction,
the case frame includes an extending portion (extending portion 36) extending from one end of each of the first flange portion, the second flange portion, and the main body portion in the first direction,
the extending portion of the case frame extends upward along an outer surface of the second side wall of the case and is joined to the outer surface of the second side wall,
the battery frame includes an extending portion (extending portion 56) extending from one end of the battery frame in the first direction, and
the extending portion of the battery frame extends upward along an inner surface of the second side wall of the case and is joined to the inner surface of the second side wall.

According to the battery pack of the above (6), the rigidity of the case frame and the battery frame can be increased.

(7) The battery pack according to the above (6), in which
the extending portion of the case frame, the extending portion of the battery frame, and the second side wall of the case are integrally joined.

According to the battery pack of the above (7), the rigidity of the case frame, the battery frame, and the case as a whole can be increased.

(8) The battery pack according to the above (6) or (7), in which
the extending portion of the case frame includes
   a first flange extending portion (first flange extending portion 37) continuous with the first flange portion, and
   a second flange extending portion (second flange extending portion 38) continuous with the second flange portion,
the first flange extending portion has an expanded joining portion (expanded joining portion 37a) that is wider than the first flange portion in the second direction and is joined to the outer surface of the second side wall of the case, and
the second flange extending portion has an expanded joining portion (expanded joining portion 38a) that is wider than the second flange portion in the second direction and is joined to the outer surface of the second side wall of the case.

According to the battery pack of the above (8), when the extending portion of the case frame, the extending portion of the battery frame, and the second side wall of the case are integrally joined, a sufficient joining region can be provided at the extending portions.

### REFERENCE SIGNS LIST

1 vehicle
2 vehicle body
3 seat
4 floor panel
10 battery pack
11 battery
12 case
13 case body
14 case cover
15 junction box
20 bottom wall
21, 22, 23, 24 side wall
30 first case frame
33 first flange portion
34 second flange portion
35 main body portion
36 extending portion
37 first flange extending portion
37a expanded joining portion
38 second flange extending portion
38a expanded joining portion
39 main body extending portion
40 second case frame
50 first battery frame
51 bottom portion
52 top portion
53 connection portion
54 fixing base
56 extending portion
60 second battery frame
M motor
P1 first position
P2 second position

What is claimed is:

1. A battery pack to be mounted on a vehicle, the battery pack comprising:
a battery;
a case accommodating the battery;
a case frame disposed outside the case and configured to fix the case to a vehicle body; and
a battery frame disposed inside the case and configured to fix the battery to the case, wherein
the case includes
a bottom wall on which the battery is placed, and
a first side wall extending upward from a first edge of the bottom wall extending in a first direction, the first side wall facing the battery in a second direction orthogonal to the first direction,
the case frame includes
a first flange portion extending in the first direction along the bottom wall of the case and joined to an outer surface of the bottom wall,
a second flange portion disposed at an interval from the first flange portion in the second direction, extending in the first direction along the bottom wall of the case, and joined to the outer surface of the bottom wall, and
a main body portion connecting the first flange portion and the second flange portion and forming a closed cross section with the bottom wall of the case in a cross section perpendicular to the first direction,
the battery frame includes a bottom portion extending in the first direction along the bottom wall of the case and joined to an inner surface of the bottom wall, and
when viewed from above, at least a part of the bottom portion of the battery frame overlaps one of the first flange portion or the second flange portion of the case frame.

2. The battery pack according to claim 1, wherein
the bottom portion of the battery frame, the bottom wall of the case, and one of the first flange portion or the second flange portion of the case frame are integrally joined.

3. The battery pack according to claim 1, wherein
the battery frame includes
a top portion extending in the first direction while being separated upward from the bottom wall of the case, and supporting the battery, and
a connection portion connecting the bottom portion and the top portion,
the connection portion extends upward from, among edges on both sides of the bottom portion in the second direction, an edge near the first side wall of the case, and
the top portion extends from an upper end of the connection portion toward the first side wall of the case.

4. The battery pack according to claim 2, wherein
the battery frame includes
a top portion extending in the first direction while being separated upward from the bottom wall of the case, and supporting the battery, and
a connection portion connecting the bottom portion and the top portion,
the connection portion extends upward from, among edges on both sides of the bottom portion in the second direction, an edge near the first side wall of the case, and
the top portion extends from an upper end of the connection portion toward the first side wall of the case.

5. The battery pack according to claim 3, wherein
the battery is disposed on a side opposite to the first side wall of the case with respect to the top portion of the battery frame, and
a bottom of the battery is located lower than the top portion of the battery frame.

6. The battery pack according to claim 4, wherein
the battery is disposed on a side opposite to the first side wall of the case with respect to the top portion of the battery frame, and
a bottom of the battery is located lower than the top portion of the battery frame.

7. The battery pack according to claim 3, wherein
fixing bases to which the battery is fixed are respectively provided at both end portions, in the first direction, of the top portion,
each of the fixing bases protrudes further toward a side opposite to the first side wall of the case along the second direction than an intermediate portion, in the first direction, of the top portion, and
each of both end portions, in the first direction, of the connection portion continuous with the fixing bases bulges further toward the side opposite to the first side wall of the case along the second direction than an intermediate portion, in the first direction, of the connection portion.

8. The battery pack according to claim 4, wherein
fixing bases to which the battery is fixed are respectively provided at both end portions, in the first direction, of the top portion,
each of the fixing bases protrudes further toward a side opposite to the first side wall of the case along the second direction than an intermediate portion, in the first direction, of the top portion, and
each of both end portions, in the first direction, of the connection portion continuous with the fixing bases bulges further toward the side opposite to the first side wall of the case along the second direction than an intermediate portion, in the first direction, of the connection portion.

9. The battery pack according to claim 1, wherein
the case includes a second side wall that extends upward from a second edge of the bottom wall extending in the second direction and that faces the battery in the first direction,
the case frame includes an extending portion extending from one end, in the first direction, of each of the first flange portion, the second flange portion, and the main body portion,
the extending portion of the case frame extends upward along an outer surface of the second side wall of the case and is joined to the outer surface of the second side wall,
the battery frame includes an extending portion extending from one end, in the first direction, of the battery frame, and
the extending portion of the battery frame extends upward along an inner surface of the second side wall of the case and is joined to the inner surface of the second side wall.

10. The battery pack according to claim 9, wherein
the extending portion of the case frame, the extending portion of the battery frame, and the second side wall of the case are integrally joined.

11. The battery pack according to claim 9, wherein
the extending portion of the case frame includes
a first flange extending portion continuous with the first flange portion, and
a second flange extending portion continuous with the second flange portion,
the first flange extending portion has an expanded joining portion that is wider than the first flange portion in the second direction and is joined to the outer surface of the second side wall of the case, and
the second flange extending portion has an expanded joining portion that is wider than the second flange portion in the second direction and is joined to the outer surface of the second side wall of the case.

12. The battery pack according to claim 10, wherein
the extending portion of the case frame includes
a first flange extending portion continuous with the first flange portion, and
a second flange extending portion continuous with the second flange portion,
the first flange extending portion has an expanded joining portion that is wider than the first flange portion in the second direction and is joined to the outer surface of the second side wall of the case, and
the second flange extending portion has an expanded joining portion that is wider than the second flange portion in the second direction and is joined to the outer surface of the second side wall of the case.
